(19) United States
(12) Patent Application Publication
(10) Pub. No.: US 2014/0162733 A1
(43) Pub. Date: Jun. 12, 2014

(54) DEVICE HOLDER

(71) Applicant: Ted Cole, Wyoming, MI (US)

(72) Inventor: Ted Cole, Wyoming, MI (US)

(21) Appl. No.: 13/706,519

(22) Filed: Dec. 6, 2012

(51) Int. Cl. H04M 1/04

(52) U.S. Cl. CPC H04M 1/04
USPC 455/575.1

(57) ABSTRACT

Device, such as a cell phone holder that mounts on, or can be integral with a laptop computer or similar device is disclosed, including a rear view mirror. The present invention may become part of the laptop or rear view mirror. It is extremely compact, essentially invisible when not in use, holds the phone securely, is attractive, and positionally puts the phone in the most ideal location relative to the laptop screen.

### BACKGROUND OF THE INVENTION

This invention relates to an apparatus that allows for a cell device or other similarly sized device to be securely disposed adjacent to a screen or screen housing. The apparatus also allows the user to not have to set their device on their desk.

Most laptop computer users also have their smart device lying out on their desk, often plugged into the USB of their laptop. The smart device's data stream is now an integral part of work flow. An ideal location of a smart device to visually include its datastream would be directly adjacent to the laptop screen. The holding device keeping it in that location would need to be light, compact, essentially disappear when not in use, and hold the device securely.

Other mounts are either bulky or impractical, or are separate from the laptop, nullifying their value in cramped scenarios like airplanes, subways, busses, airports, chairs, small desks, etc. They also positionally do not hold the device in the ideal location, right adjacent to and flush with the laptop screen. They also do not hold it ruggedly.

The present invention becomes part of the laptop, is extremely compact, essentially invisible when not in use, holds the device securely, is attractive, and positionally puts the device in the most ideal location relative to the laptop screen.

As can be seen, there is a need for an apparatus that among other things, provides for device placement immediately in view, off of a desk, and adjacent a screen, tablet, monitor, or other structure.

### SUMMARY OF THE INVENTION

One aspect of the present invention is a device holder (10), comprising: an inside wall (50) and an outside wall (40); said outside wall (40) can bias toward and away from said inside wall (50); and a biasing means (170) that forces said outside wall (40) toward said inside wall (50); whereby the device holder (10) is capable of positioning a device (20) next to a screen (260) so that a person can see both the screen (260) and the device (20) without turning one's head.

Another aspect of the present invention is a device holder (10), comprising: an inside wall (50) and an outside wall (40); said outside wall (40) can bias toward and away from said inside wall (50); and a biasing means (170) that forces said outside wall (40) toward said inside wall (50); whereby the device holder (10) positions a device (20) adjacent to a screen (260).

These and other features, aspects and advantages of the present invention will become better understood with reference to the following drawings, description and claims.

### BRIEF DESCRIPTION OF THE DRAWINGS

FIG. 1 illustrates a pictorial front view of an embodiment of the present invention;

FIG. 2 illustrates a pictorial rear view of an embodiment of the present invention; and

FIG. 3 illustrates a pictorial view of an embodiment of the present invention;

FIG. 4 illustrates a pictorial view of an embodiment of an arm of the present invention;

FIG. 5 illustrates a pictorial view of an embodiment of an assembly of an arm of the present invention;

FIG. 6 illustrates a pictorial view of an embodiment of the present invention not secured to a computer or similar device;

FIG. 7 illustrates a pictorial view of an embodiment of the present invention; and

FIG. 8 illustrates a pictorial view of an embodiment of the present invention on a rear view mirror.

### DETAILED DESCRIPTION OF THE INVENTION

10 device holder

20 device

30 screen casing

40 outside wall

50 inside wall

60 rear wall

70 device holder housing

80 indent

90 front side

100 back side

110 indicia panel

120 attachment means

130 means to secure the front side to the back side

140 screw

150 screw hole

160 slot

170 biasing means

180 spring

190 finger tab

200 securement tab

210 tab indent

220 rail

230 rail indent

240 [INTENTIONALLY LEFT BLANK]

250 spring holder

260 screen

270 direction of displacement

280 alternating extensions

290 back side inner surface

300 rubberized pad

The following detailed description is of the best currently contemplated modes of carrying out the invention. The description is not to be taken in a limiting sense, but is made merely for the purpose of illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

The present invention is very thin and compact and may be mounted onto the back surface of a Laptop LCD screen or standalone LCD screen, positioned on the left or right side edge. The biasing tray opens wide enough to receive any size cell phone, holding it securely in place directly adjacent to the LCD screen. Rubber pads and small ridges on the side-gripping surfaces aid in securing the phone. When the phone is removed, the tray fully closes, making the device essentially disappear visually. Nothing like this currently exists on the market, offering such compactness & holding the phone in such an ideal location relative to the LCD screen.

The present invention does not clip on and off like previous, bulky cell phone mounts. When not in use, the device essentially disappears from view, and is so thin its presence even during transport is almost invisible. It holds the phone ruggedly, even in rough environments like bumpy airplane rides, sitting on lazy boys, and sitting in airports, etc. It positions the phone directly adjacent to and flush with the laptop's screen, and is part of the laptop, not a separate mount. As a result, the laptop and phone becomes one synergistic device. The laptop can even be closed and carried with the phone still in the mount.

Alternatively, the present invention 10 may be incorporated in the notebook computer or tablet, similar to DVD or CD drives in current computers.

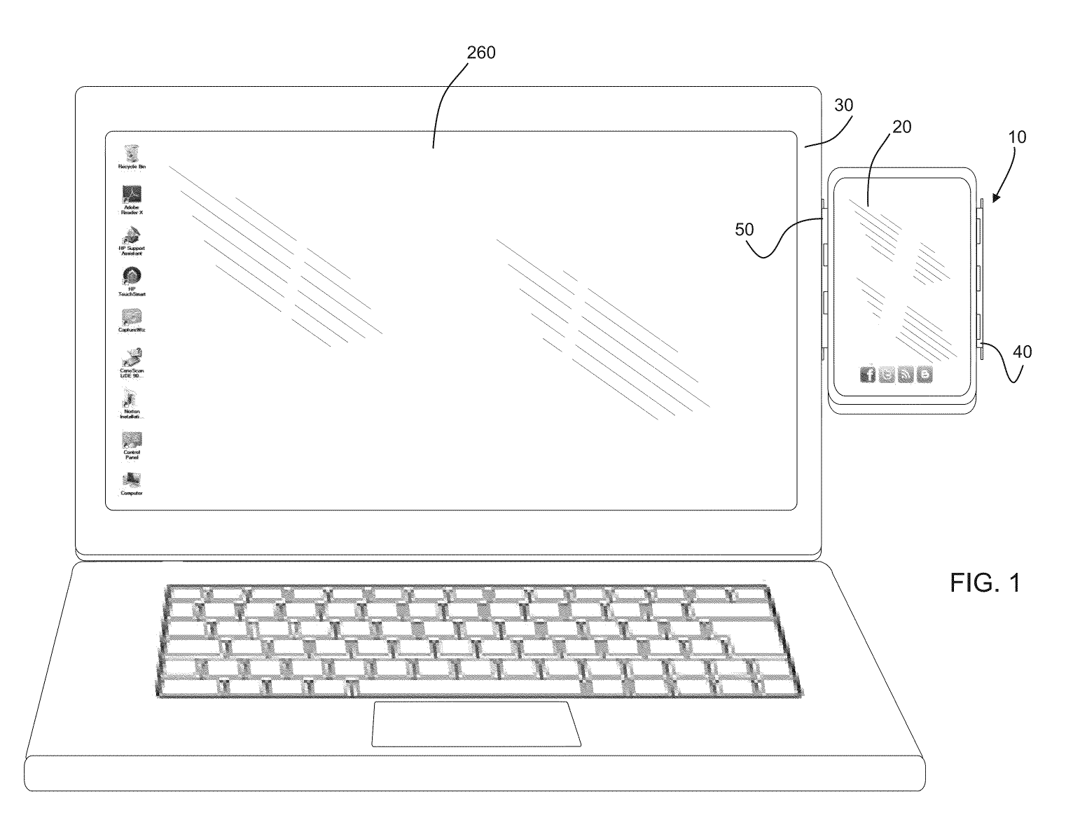

FIG. 1 illustrates a common notebook computer having a screen 260 and a screen casing 30. The device holder 10 is shown with a device 20, such as a phone secured next to the screen 260, secured between an outside wall 40 and an inside wall 50.

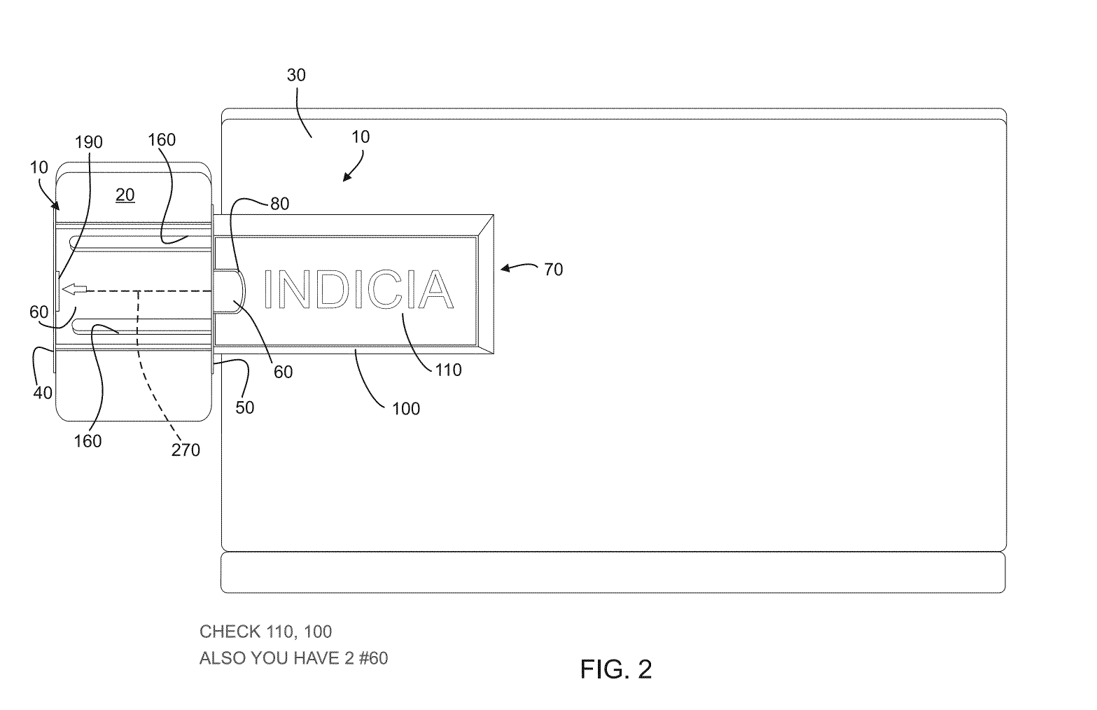

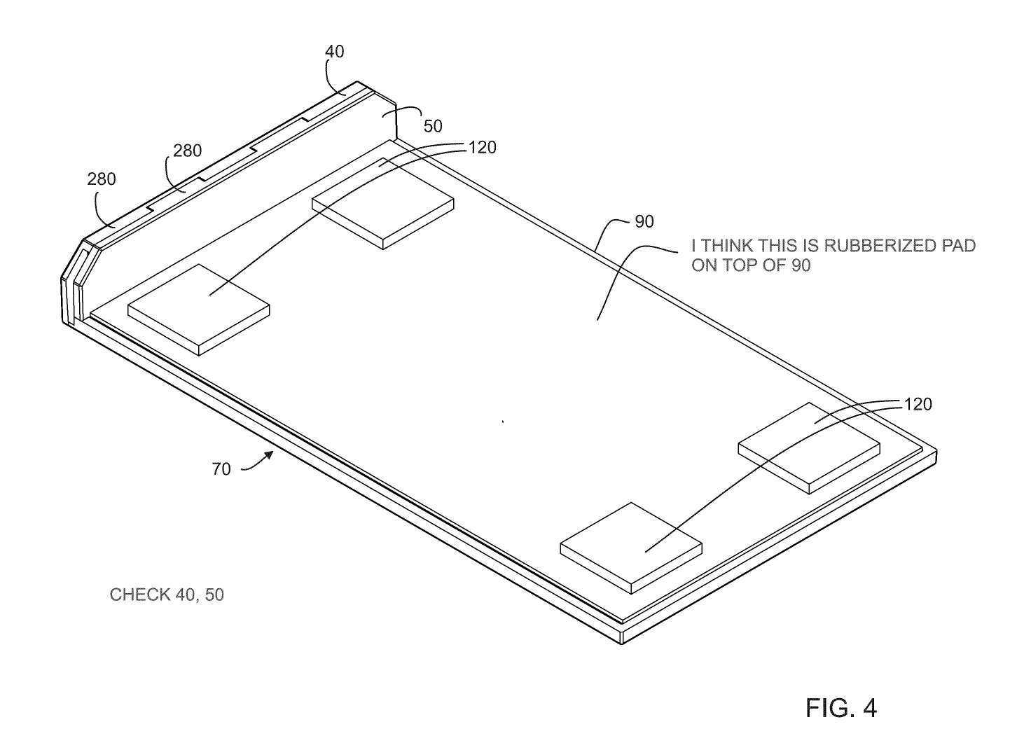

FIG. 2 illustrates the back of the notebook computer. The device holder 10 is shown attached to the back of the computer on the screen casing 30, and the device holder 10 is in the open position. The device holder housing 70 is secured to the screen casing 30. The device holder housing 70 may have a front side 90 (shown in FIG. 4) that may attach to the screen casing 30. In one embodiment the front side 90 may have an attachment means 120 to attach the front side 90 to the screen casing 30. In one embodiment the attachment means 120 may be double sided tape, or double sided foam tape, or related peel and stick adhesive. In one embodiment 3M command strips® may be used to attach the device holder 10 to the computer or tablet.

FIG. 2 also shows the back side 100 having an indicia panel 110 thereon; thus enabling an employer to place its name on the device holder 10, or for promotional purposes.

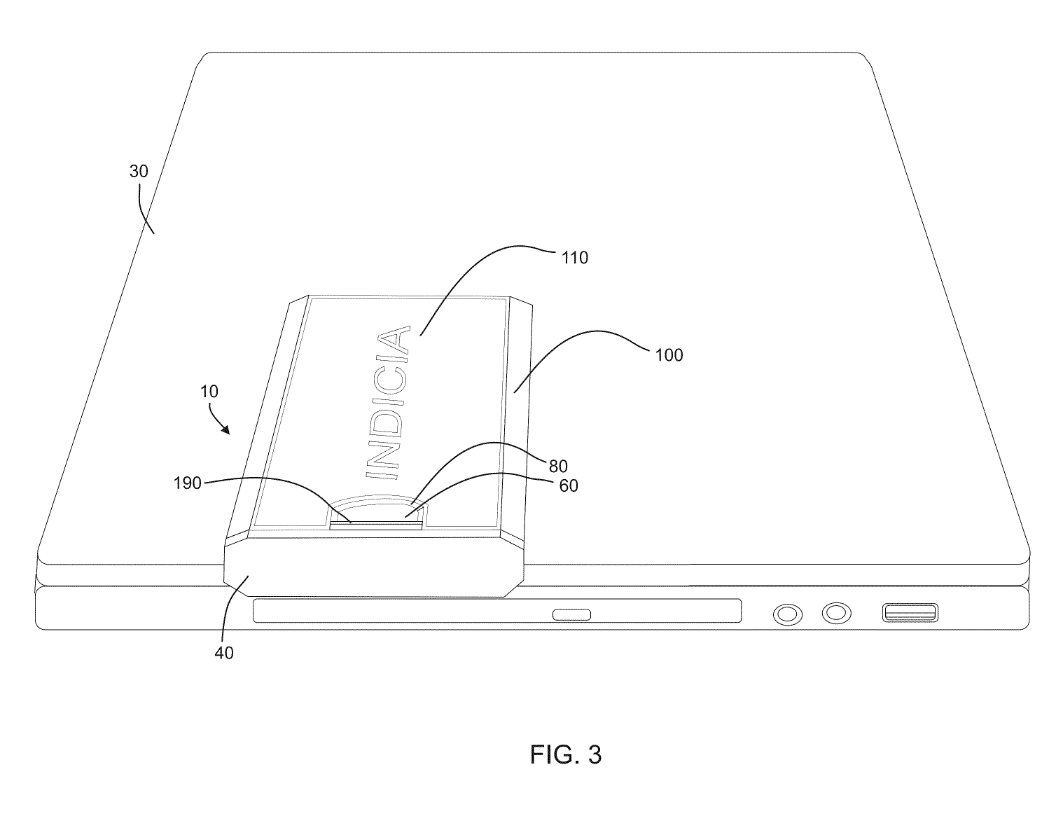

FIG. 2 illustrates a device 20 secured between the outside wall 40 and the inside wall 50, and in contact with a rear wall 60. A finger tab 190 is shown that is disposed rearwardly of the outside wall 40. The back side 100 may have an indent 80 that is may be a semi-circular cutout to expose at least a portion of the rear wall 60 when the device holder 10 in is the closed position, as illustrated in FIG. 3.

FIG. 2 also illustrates the rear wall 60 having a longitudinal slot 160 substantially parallel to the direction of displacement 270.

FIG. 3 illustrates the device holder 10 in the closed position. A biasing means 170 may force the outside wall 40 toward the inside wall 50 to when a device is not disposed between the outside wall 40 and the inside wall 50. In one embodiment of the device holder 10, the outside wall 40 may be displaced away from said inside wall 50 by moving a finger tab 190. In one embodiment the back side 100 may have a c-shaped or semi-circular cut out to define an indent to allow a person to place a finger on the finger tab 190 to move the outside wall 40 away from the inside wall 50, or otherwise in an open position.

FIG. 4 illustrates an embodiment of the present invention 10. The front side 90 is illustrated. The front side 90 may be secured to the back of a screen casing 30, such as notebook computer or tablet. An attachment means 120 may secure the front side 90 to the screen casing 30. In one embodiment the attachment means 120 may be double sided adhesive tape, or double sided adhesive foam.

FIG. 4 also shows an embodiment where the outside wall 40 and the inside wall 50 have alternating extensions 28 that are position such that the outside wall 40 is flush with the inside wall 50 when the device holder 10 is in the closed position.

The alternating extensions 280 may also assist in securing a device 20 in the device holder 10 if the alternating extension 280 is disposed forwardly from the device 20.

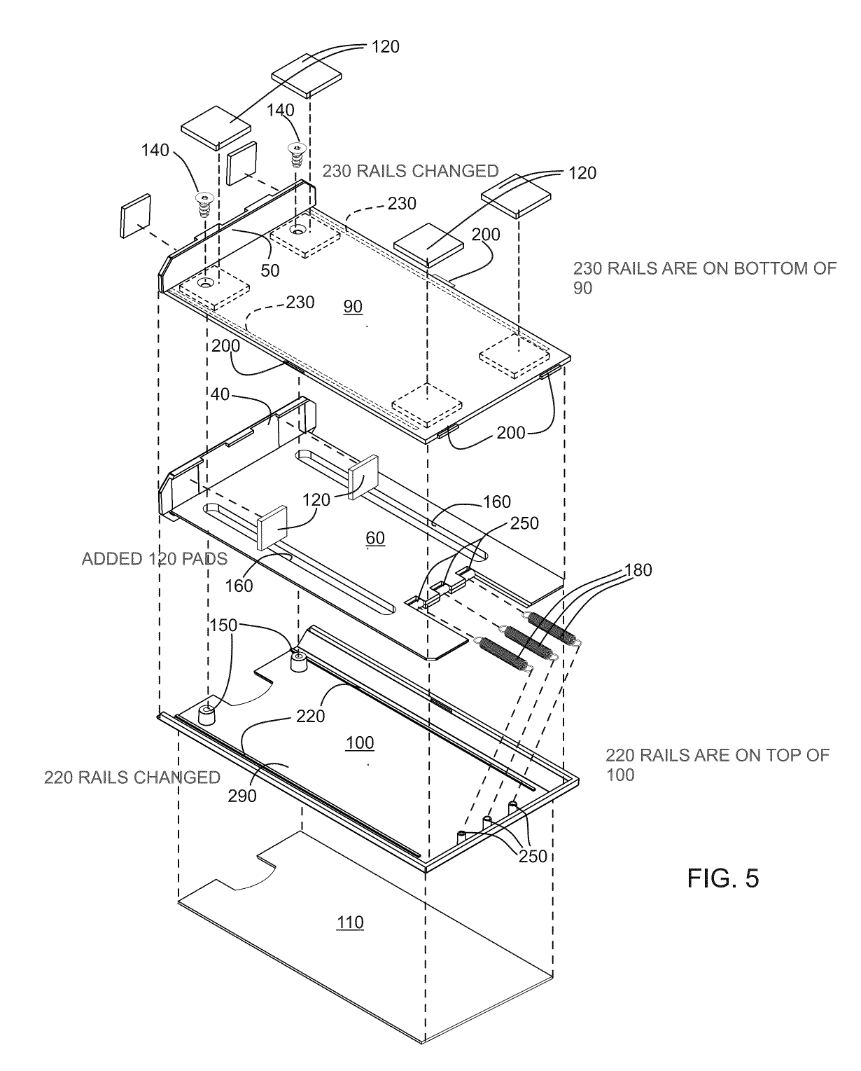

FIG. 5 illustrates an embodiment of an assembly of the present invention 10. The front side 90 may have an inside wall 50 integral therewith and the inside wall 50 may extend forwardly. The front side 90 may have means to secure 130 the front side 90 to the back side 100. In one embodiment, the means to secure 130 may be two screws 140 that go through the front side 90 to be screwed into screw holes 150 in the back side 100.

The rear wall 60 may be slidably disposed between said front wall 90 and the back wall 100. The screw 140 may go through a slot 160, or two slots 160 in the rear wall 60. The screw 140 may act as a stop, to prevent the rear wall 60 from falling out by limiting its travel or displacement. The rear wall 60 may have an outside wall 40 integral therewith, that extends forwardly from said rear wall 60. In one embodiment the inside wall 40 is flush with the outside wall 50 when the device holder 10 is in the closed position.

FIG. 5 also illustrates that one embodiment of the biasing means 170 may be a spring 180, or three springs 180. The spring 180 may be connected at one end to the back side 100, and at the other to the rear wall 60 to force the device holder in the closed position, or may force the outside wall 40 toward the inside wall 50. An indicia panel 100 may be secured to the back side 100 so it is visible.

FIG. 5 illustrates an embodiment of the present invention 10 where the back side 100 has a rail back 220 on its inner surface 290. There may a rear wall rail 230 on the adjacent surface of the rear wall 60. The back rail 220 and the rear wall rail 230 may be in sliding contact with each other. This prevents the rear wall 60 from contacting the back side 100, which reduces surface area of friction.

FIG. 5 illustrates an embodiment of the present invention 10 where the back side 100 has a rail back 220 on its inner surface 290. There may be a rear wall rail 230 on the adjacent surface of the rear wall 60. The back rail 220 and the rear wall rail 230 may be in sliding contact with each other. This prevents the rear wall 60 from contacting the back side 100, which reduces surface area of friction.

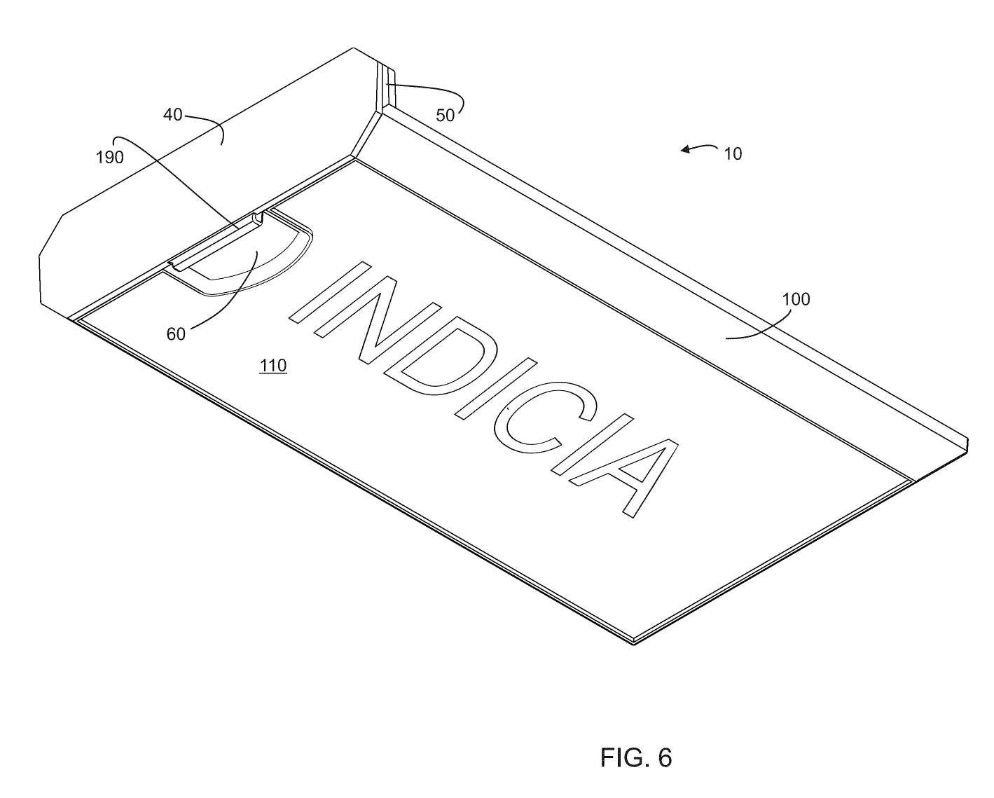

FIG. 6 illustrates an embodiment of the present invention 10 in the closed position.

A finger tab 190 may be disposed on the outside wall 40 to aid in moving or displacing the outside wall 40 or the rear wall 60.

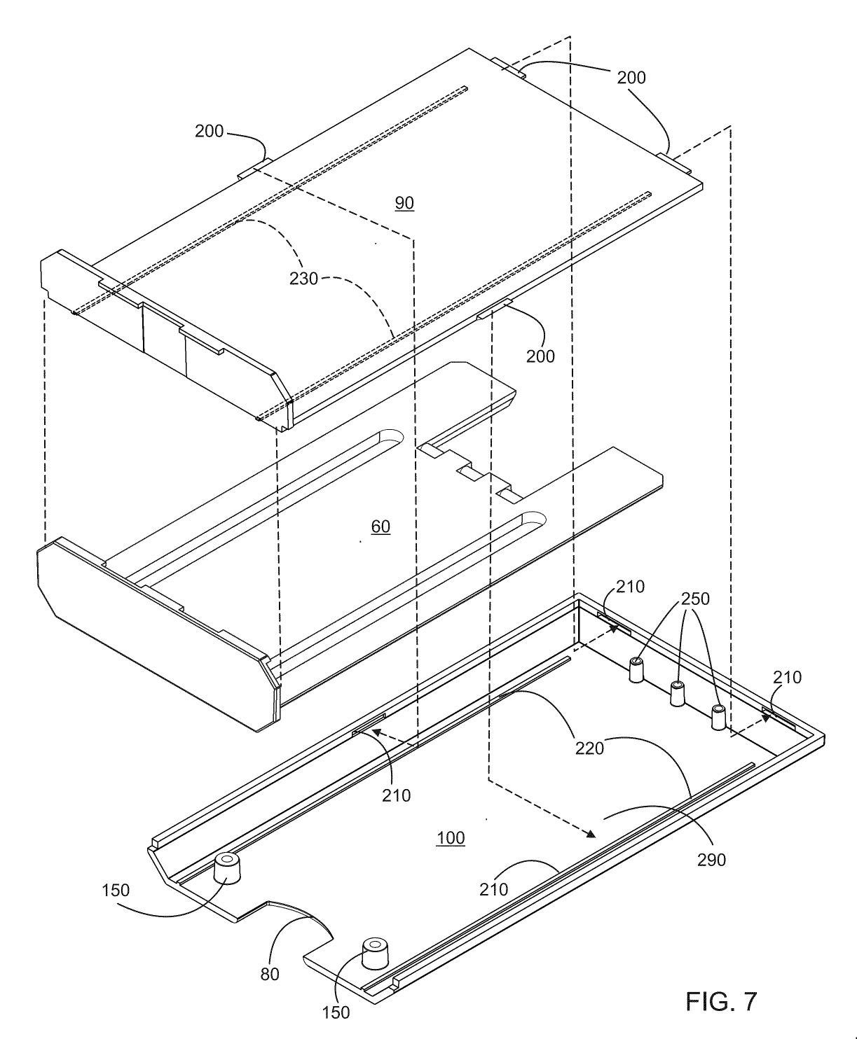

FIG. 7 also illustrates an embodiment where the front side 90 has a securement tab 200 extending from an edge. The back side 100 may have tab indents for receiving the securement tab 200. The positioning of the securement tab 200 in the tab indents may provide illustrates an embodiment of the present invention 10 where the back side 100 has a rail back 220 on its inner surface 290. There may a rear wall rail 230 on the adjacent surface of the rear wall 60. The back rail 220 and the rear wall rail 230 may be in sliding contact with each other. This prevents the rear wall 60 from contacting the back side 100, which reduces surface area of friction.

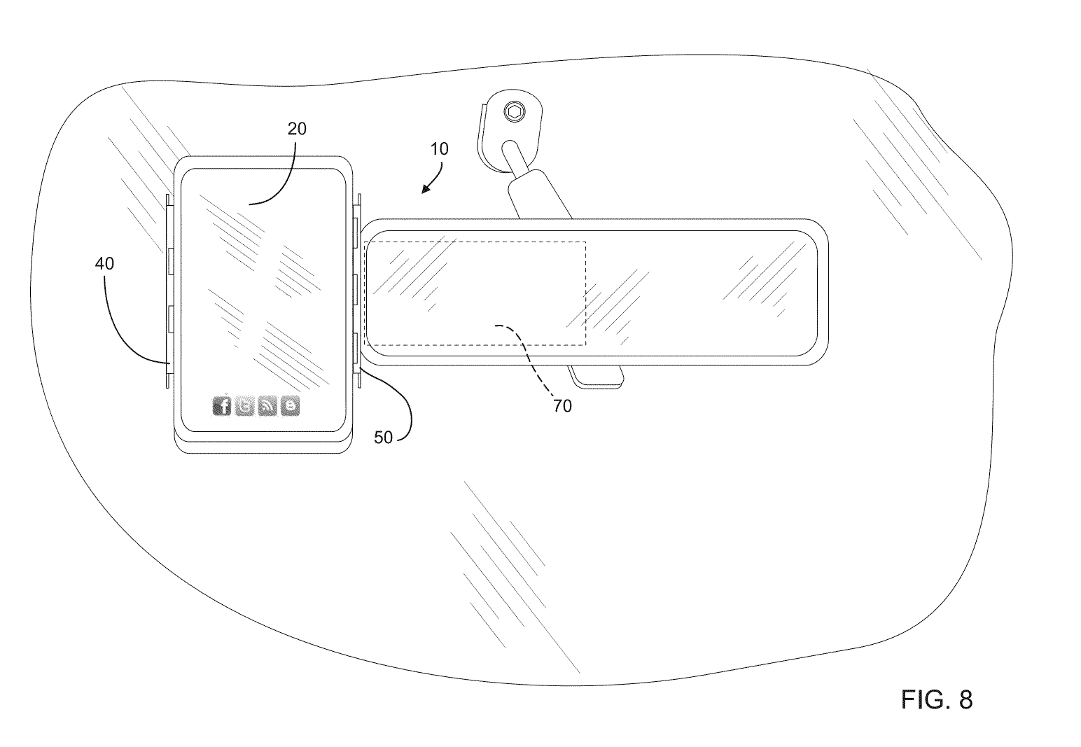

FIG. 8 illustrates an embodiment of the present invention operable with rear view mirror of a motor vehicle. The device holder housing 70 may be secured to a rear view mirror so that the user can view the device 20 as it is adjacent the rear view mirror inside a motor vehicle.

It should be understood, of course, that the foregoing relates to exemplary embodiments of the invention and that modifications may be made without departing from the spirit and scope of the invention as set forth in the following claims.

I claim:

1. A device holder (10), comprising:
an inside wall (50) and an outside wall (40);
said outside wall (40) can bias toward and away from said inside wall (50); and
a biasing means (170) that forces said outside wall (40) toward said inside wall (50).

2. The apparatus of claim 1, whereby the device holder (10) is capable of positioning a device (20) next to a screen (260) so that a person can see both the screen (260) and the device (20) without turning one's head.

3. The apparatus of claim 1, wherein:
said biasing means (170) is connected to a rear wall (60) and said outside wall (40) is integral with said rear wall (60).

4. The apparatus of claim 1, further comprising:
a device holder housing (70) having a front side (90) and a back side (100);
a rear wall (60) slidably disposed between said front side (90) and said back side (100).

5. The apparatus of claim 4, further comprising:
an indicia panel (110) secured to said back side (100);
said indicia panel (110) so that said indicia panel (110) is visible.

6. The apparatus of claim 4, further comprising:
said rear wall (60) has a slot (160) therein;
a screw (140) connects said front side (90) to said back side (100);
said screw is disposed through said slot (160), whereby said outside wall (40) can be displaced away from said inside wall (50) until said screw (140) contacts an end of said slot (160).

7. The apparatus of claim 4, further comprising:
said back side (100) has an indent (80) that allows a finger tab (190) to be displaced away from said inside wall (50) to place a device (20) between said outside wall (40) and inside wall (50) so that the device is held in place by the outside wall (40) forced toward said inside wall (50) by said biasing means (170).

8. The apparatus of claim 1, wherein said biasing means is a spring (180) connected at one end to said rear wall (60) and at another end to said back side (100).

9. The apparatus of claim 4 wherein said back side (90) is removably secured to a screen casing (30).

10. The apparatus of claim 4, further comprising:
said back side (100) having a back rail (220) disposed lengthwise;
said rear wall (60) having a rear wall rail (230) disposed lengthwise that is in sliding contact with said back rail (220) when said rear wall (60) is displaced with respect to said back side (100).

11. The apparatus of claim 4, further comprising:
said front side (90) having a securement tab (200) extending from an edge of said front side (90);
said back side (100) having a tab indent (210) disposed on an inside edge; said tab indent (210) receives said securement tab (200)

12. A device holder (10), comprising:
an inside wall (50) and an outside wall (40);
said outside wall (40) can bias toward and away from said inside wall (50); and
a biasing means (170) that forces said outside wall (40) toward said inside wall (50); whereby the device holder (10) positions a device (20) adjacent to a screen (260).

13. The apparatus of claim 11, wherein:
said biasing means (170) is connected to a rear wall (60) and said outside wall (40) is integral with said rear wall (60).

14. The apparatus of claim 11, further comprising:
a device holder housing (70) having a front side (90) and a back side (100);
a rear wall (60) slidably disposed between said front side (90) and said back side (100).

15. The apparatus of claim 13, further comprising:
an indicia panel (110) secured to said back side (100) so that said indicia panel (110) is visible.

16. The apparatus of claim 13, further comprising:
said rear wall (60) has a slot (160) therein;
a screw (140) connects said front side (90) to said back side (100);
said screw is disposed through said slot (160), whereby said outside wall (40) can be displaced away from said inside wall (50) until said screw (140) contacts an end of said slot (160).

17. The apparatus of claim 13, further comprising:
said back side (100) has an indent (80) that allows a finger tab (190) to be displaced away from said inside wall (50) to place the device (20) between said outside wall (40) and inside wall (50) so that the device is held in place by the outside wall (40) forced toward said inside wall (50) by the biasing means (170).

18. The apparatus of claim 11, wherein said biasing means is a spring (180) connected at one end to said rear wall (60) and at another end to said back side (100).

19. The apparatus of claim 13, wherein said back side (90) is removably secured to a screen casing (30).

20. The apparatus of claim 13, further comprising:
said back side (100) having a back rail (220) disposed lengthwise;
said rear wall (60) having a rear wall rail (230) disposed lengthwise that is in sliding contact with said back rail (220) when said rear wall (60) is displaced with respect to said back side (100).
